(19) United States
(12) Patent Application Publication
(10) Pub. No.: US 2019/0255599 A1
(43) Pub. Date: Aug. 22, 2019

(54) AQUEOUS AKALINE BINDER COMPOSITION FOR CURING WITH CARBON DIOXIDE GAS AND USE THEREOF, CORRESPONDING MOULDING MIXTURE FOR A PRODUCING FOUNDRY SHAPE, A CORRESPONDING FOUNDRY SHAPE AND A METHOD FOR PRODUCING A FOUNDRY SHAPE

(71) Applicant: HÜTTENES-ALBERTUS CHEMISCHE WERKE GESELLSCHAFT MIT BESCHRÄNKTER HAFTUNG, Düsseldorf (DE)

(72) Inventors: Gérard LADÉGOURDIE, Düsseldorf (DE); Nicolas EGELER, Krefeld (DE)

(73) Assignee: HÜTTENES-ALBERTUS CHEMISCHE WERKE GESELLSCHAFT MIT BESCHRÄNKTER HAFTUNG, Düsseldorf (DE)

(21) Appl. No.: 16/313,770

(22) PCT Filed: Jun. 28, 2017
(86) PCT No.: PCT/EP2017/065976

§ 371 Date: Dec. 27, 2018

(30) Foreign Application Priority Data
Jun. 30, 2016 (DE) 10 2016 211 971.0

(51) Int. Cl. B22C 1/22; B22C 9/12; B22C 1/16; C08K 5/5435; C08K 3/38

(52) U.S. Cl. CPC B22C 1/2253; B22C 9/123; C08K 3/38; B22C 1/167; C08K 5/5435; B22C 1/162

(57) ABSTRACT

The invention relates to an aqueous alkaline binder composition for curing with carbon dioxide gas, comprising a negatively charged or uncharged phenol-aldehyde resin, comprising phenol groups, which is selected from the group consisting of resoles and mixtures comprising one or more resoles and also one or more novolacs, an oxyanion selected from the group consisting of borate ions, aluminate ions, stannate ions, zirconate ions, titanate ions, and mixtures thereof, for forming a stable complex with the resole phenol-aldehyde resin, where the total molar amount of the phenol groups of the phenol-aldehyde resin in the aqueous alkaline binder composition is in the range from 1 to 3 mol/kg, based on the total mass of the aqueous alkaline binder composition, and where the phenol-aldehyde resin possesses an average molecular weight (Mw) in the range from 750 to 1200 g/mol, determined by means of gel permeation chromatography. The invention relates, moreover, to a corresponding use, to a molding mixture for producing a foundry molding, and also to a corresponding method for producing a foundry molding, and to a corresponding foundry molding.

The present invention relates to an aqueous alkaline binder composition for curing with carbon dioxide gas, to the use of the aqueous alkaline binder composition, to a molding mixture for producing a foundry molding, and also to a corresponding method for producing a foundry molding and to a corresponding foundry molding.

The invention is defined in the claims, and specific aspects of the invention are defined and described below.

In the foundry industry there are three main types of foundry moldings. Cores and molds are foundry moldings which, generally in combination with one another, represent the negative shape of a casting that is to be produced. Feeder elements form hollow bodies which serve as a compensatory reservoir in order to prevent formation of cavities. These foundry moldings generally comprise a mold base material, as for example silica sand or another refractory material, or a corresponding molding mixture, and a suitable binder, which gives sufficient mechanical strength to the foundry molding after removal from the mold. A molding mixture is typically and preferably in a free-flowing form, allowing it to be introduced into a suitable hollow mold and compacted therein. Added binder generates a strong cohesion between the particles of the mold base material, and so the resultant foundry molding acquires the requisite mechanical stability. The foundry moldings themselves are required to meet various requirements, with sufficiently high strength being one example.

Within the foundry industry, problems frequently occur in particular with very delicate foundry moldings, since such moldings require particularly high strength (i.e., stability) so that stability is sufficient on casting. This applies in particular to freshly cured foundry moldings.

Known from the prior art are the following documents:

DE 10 2005 024 334 A1 is concerned with a “Cold-box binder system using saturated fatty acid esters” (designation).

EP 0 363 385 B1 relates to “Modifiers for aqueous basic solutions of phenolic resins” (title).

WO 03/016400 A1 relates to a “Resole-based, CO₂-curable binder system” (designation).

EP 0 323 096 B1 relates to the “Production of articles of bonded particulate material and binder compositions for use therein” (title).

WO 97/18913 relates to a “Cold-box process for preparing foundry shapes” (title).

U.S. Pat. No. 5,242,957 A relates to “Alkaline resol phenol-aldehyde resin binder compositions containing phenyl ethylene glycol ether” (title).

U.S. Pat. No. 5,198,478 A relates to “Alkaline resol phenol-aldehyde resin binder compositions” (title).

WO 01/12709 A1 relates to a “Resole-based, aluminum- and boron-containing binder system” (title).

U.S. Pat. No. 5,294,648 A relates to an “Alkaline resol phenol-aldehyde resin binder composition” (title).

EP 2 052 798 A1 relates to “Alkaline resol phenol-aldehyde resin binder compositions” (title).

EP 0 503 758 B1 relates to a “Binder comprising alkaline phenol-aldehyde resole resins” (title).

U.S. Pat. No. 4,977,209 A relates to the “Production of articles of bonded particulate material and binder compositions for use therein from phenol-formaldehyde and oxyanion” (title).

GB 2 253 627 A relates to “Alkaline resol phenol-aldehyde resin binder compositions” (title).

U.S. Pat. No. 5,162,393 relates to the “Production of foundry sand moulds and cores” (title).

U.S. Pat. No. 4,985,489 relates to the “Production of articles of bonded particulate material and binder compositions for use therein” (title).

EP 2 052 798 B1 relates to a “Binder composition comprising alkaline phenol-aldehyde resole resins” (title).

EP 0 508 566 B1 relates to “Alkaline resol phenol-aldehyde resin binder compositions” (title).

EP 0 503 759 B1 relates to “Alkaline resol phenol-aldehyde resin binder compositions” (title).

EP 0 556 955 B1 relates to an “Alkaline resole phenol-aldehyde resin binder” (title).

A primary object of the present invention was to provide an aqueous alkaline binder composition for curing with carbon dioxide gas that allows the production of particularly stable foundry moldings (i.e., foundry moldings of particularly high strength), more especially particularly stable sized foundry moldings.

With preference, one or more further objects ought to be achieved in accordance with specific aspects:

According to one specific aspect, an object of the present invention was to provide an aqueous alkaline binder composition for curing with carbon dioxide gas that allows the production of foundry moldings which in comparison exhibit particularly high strength both after a short storage time (for example, after 1 hour) and after long storage times (of 24 hours or longer, including at high humidities) under customary storage conditions. Particularly high strength ought preferably to be retained after washing with customary water washes as well.

According to a further specific aspect, an object of the present invention was to provide an aqueous alkaline binder composition for curing with carbon dioxide gas that exhibits particularly high, preferably increased, flowability in comparison to the binder compositions known from the prior art.

According to a further specific aspect, an object of the present invention was to provide an aqueous alkaline binder composition for curing with carbon dioxide gas that in a corresponding method for producing a foundry molding exhibits particularly low, preferably reduced, odor emission in comparison to the binder compositions known from the prior art.

According to a further specific aspect, an object of the present invention was to provide an aqueous alkaline binder composition for curing with carbon dioxide gas that allows production of foundry moldings which, in comparison to the foundry moldings known from the prior art, exhibit improved surface quality and/or improved edge hardness.

According to a further specific aspect, an object of the present invention was to provide an aqueous alkaline binder composition for curing with carbon dioxide gas that allows the production of foundry moldings having particularly high, preferably higher, initial strength by comparison with the binder compositions known in the prior art.

An associated object of the present invention was to specify a corresponding use of an aqueous alkaline binder composition.

Further objects of the present invention are apparent mutatis mutandis from the observations above and are apparent from the corresponding elucidations in the text is hereinafter.

A further associated object of the present invention was to provide a corresponding molding mixture for producing a foundry molding, said mixture comprising a foundry molding material and also the aqueous alkaline binder composition for curing with carbon dioxide gas, to be specified in accordance with the primary object.

A further object of the present invention was to specify a corresponding method for producing a foundry molding.

A further object of the present invention was to specify a corresponding foundry molding.

Further objects of the present invention are apparent mutatis mutandis from the observations above and from the observations in the text hereinafter.

The primary object of the present invention is achieved by means of an aqueous alkaline binder composition for curing with carbon dioxide gas, comprising
a negatively charged or uncharged phenol-aldehyde resin, comprising phenol groups, which is selected from the group consisting of resoles and mixtures comprising one or more resoles and also one or more novolacs,
an oxyanion, selected from the group consisting of borate ions, aluminate ions, stannate ions, zirconate ions, titanate ions, and mixtures thereof, for forming a stable complex with the resole phenol-aldehyde resin,

where the total molar amount of the phenol groups of the phenol-aldehyde resin in the aqueous alkaline binder composition is in the range from 1 to 3 mol/kg, based on the total mass of the aqueous alkaline binder composition

and

where the phenol-aldehyde resin possesses an average molecular weight (Mw) in the range from 750 to 1200 g/mol, determined by means of gel permeation chromatography. For the method of determination, see below.

In comparison with aqueous alkaline binder compositions known from the prior art for curing with carbon dioxide gas, the average molecular weight (Mw) of the phenol-aldehyde resin used in accordance with the invention in the binder composition of the invention is unusually high. Regarding the surprising properties linked to this, see below.

In aqueous alkaline binder compositions of the invention there is in any case at least one resole (negatively charged or uncharged); one or more novolacs (negatively charged or uncharged) may additionally be present.

Negatively charged resole and/or negatively charged novolac is present in particular when phenol groups are present in phenoxide form.

Condensation reactions of (i) phenols with (ii) aldehydes result in phenol-aldehyde resins, which depending on the proportions of the reactants, the reaction conditions, and the catalysts used, are ordered into two product classes, namely (a) novolacs and (b) resoles:
(a) Novolacs are soluble, meltable, non-self-curing, and storage-stable phenolic oligomers. They are obtained in the acidically catalyzed condensation of aldehyde and phenol in a molar ratio of 1:>1. Novolacs are phenolic resins free of methylol groups, in which the phenol groups (also called phenyl units) are linked via methylene bridges. For the definition of phenol groups and phenyl units, see below.
(b) Resoles are mixtures of hydroxymethylphenols which are linked via methylene and methylene ether bridges and are obtainable by alkalinically catalyzed reaction, or reaction catalyzed by divalent metal ions such as Zn²⁺, for example, of aldehyde and phenols in a molar ratio of 1:<1.

Preferred (uncharged) phenol-aldehyde resins for use in binder compositions of the invention are products of condensation of
(i) one or more phenols of the general formula I

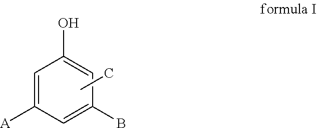

in which A, B and C independently of one another (i.e., a substituent A is defined independently, for example, from the substituent B and the substituent C, and also independently from the substituent A of another phenol of the formula I that is present) represent hydrogen, unsaturated or saturated aliphatic groups having at most 16 carbon atoms, the aliphatic groups being preferably alkyl groups which are preferably selected from the group consisting of methyl, ethyl, n-propyl, isopropyl, n-butyl, isobutyl, tert-butyl, octyl and nonyl, or are olefinic groups,
(ii) with one or more aldehydes of the general formula R′CHO, in which R′ is a hydrogen atom or an alkyl group having an alkyl main chain length of 1-8 carbon atoms.

Examples of suitable phenols covered by the formula I are phenol (C₆H₅OH), o-cresol, m-cresol, p-cresol, p-butylphenol, p-octylphenol, p-nonylphenol and cardanol (designation for compounds of the formula I where B is an aliphatic unbranched group having 15 carbons and 0, 1, 2 or 3 double bonds); of these, phenol (C₆H₅OH), o-cresol and cardanol are preferred, and phenol (C₆H₅OH) is particularly preferred.

An aldehyde generally preferred is formaldehyde, which can also be used in the form of paraformaldehyde. In practice, particular preference is given to using (i) formaldehyde as sole aldehyde or (ii) formaldehyde in combination with one or more other aldehydes.

With preference, the phenol-aldehyde resin used in accordance with the invention comprises or is a resin in which the phenyl units are linked via ortho-para or para-para methylene bridges; cf. EP 2052798 A1.

In some cases, the phenol-aldehyde used in accordance with the invention comprises or is an ortho-condensed phenolic resole, i.e., a phenolic resin of the benzyl ether resin type.

The above details concerning preferred phenols and aldehydes and also concerning preferred phenol-aldehyde resins resulting from them are also valid for the binder composition of the invention which is described in detail hereinafter. The present invention relates preferably to those phenol-aldehyde resins produced using formaldehyde.

Regarding preferred reactions and condensation products of (i) phenols of the specified general formula I with (ii) aldehydes (especially formaldehyde), reference may be made to EP 2052798 A1.

In the presence of strong bases, uncharged phenol-aldehyde resins may give up protons and be converted into corresponding, negatively charged phenol-aldehyde resins. The above statements concerning preferred uncharged phenol-aldehyde resins are valid correspondingly for the negatively charged phenol-aldehyde resins.

In an aqueous alkaline binder composition of the invention there are preferably negatively charged phenol-aldehyde resins, optionally in a mixture with uncharged phenol-aldehyde resin.

In the context of the present invention, a negatively charged or uncharged phenol-aldehyde resin comprises phenolic oligomers and/or phenolic polymers (see above) which inter alia include phenol groups or phenyl units. Considered structurally, a phenol group or a phenyl unit in the context of the present invention is a structural molecular unit of the phenol-aldehyde resin which contains exactly one aromatic ring system, conjugated in accordance with Hackers rule, having 6 delocalized electrons. Formula VII shows, schematically, a molecular unit of this kind, with R1 to R6 not belonging to the phenol group or to the phenyl unit, but instead representing substituents on the phenol group or on the phenyl unit.

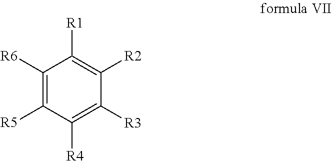

Oxyanions in the context of the present invention are preferably compounds of the formula MₓO_{y}^{-z},
where M is selected from the group consisting of B, Al, Sn, Zr and Ti
   and
where x and y and z respectively, according to the nature of the element M, are each an integral number in the range from 1 to 4.

Borate ions and aluminate ions are preferred oxyanions for use in binder compositions of the invention, with combinations of borate and aluminate being especially preferred.

In some cases, preference is given to a binder composition of the invention for curing with carbon dioxide gas (as defined above), comprising
a negatively charged or uncharged phenol-aldehyde resin, comprising phenol groups, which is selected from the group consisting of resoles and mixtures comprising one or more resoles and also one or more novolacs,
an oxyanion selected from the group consisting of aluminate ions, stannate ions, zirconate ions, titanate ions, and mixtures thereof, for forming a stable complex with the resole phenol-aldehyde resin,

where the total molar amount of the phenol groups of the phenol-aldehyde resin in the aqueous alkaline binder composition is in the range from 1 to 3 mol/kg, based on the total mass of the aqueous alkaline binder composition,

and

where the phenol-aldehyde resin possesses an average molecular weight (Mw) in the range from 750 to 1200 g/mol, determined by means of gel permeation chromatography,

and

where the binder composition contains preferably less than 1 wt % of borate ions, more preferably less than 0.1 wt %, very preferably less than 0.05 wt %, based in each case on the total mass of the aqueous alkaline binder composition, and with very particular preference contains no borate ions at all.

Regulation 1272/2008 EC classes various boron compounds as being toxicologically objectionable; in the context of the present invention, therefore, the use of boron compounds (especially borates) is preferably avoided, despite such use being entirely advantageous from a technical standpoint in some cases.

Surprisingly it has been found that binder compositions of the invention which comprise a phenol-aldehyde resin having an aforementioned average molecular weight (Mw) lead to particularly high flexural strength on the part of the resultant foundry moldings after a storage time of 24 hours and after 5 days under standard storage conditions and also after the wash treatment of the foundry moldings. Normal storage conditions are present, for example, at 20° C. (+/−2° C.), atmospheric pressure and a relative humidity of 47% (+/−2%).

Surprisingly, moreover, it has been found that binder compositions of the invention which comprise a phenol-aldehyde resin having an average molecular weight (Mw) within the above-stated range lead to particularly high strength on the part of the resultant foundry moldings after a storage time of 15 seconds (i.e., “initial strength”) under normal storage conditions; regarding preferred average molecular weights of the phenol-aldehyde resin, see below. This makes it possible to produce particularly delicate foundry moldings. In our own investigations, the resulting foundry moldings have proven to be particularly stable to atmospheric humidity; consequently, they can be stored for a long time even without absence of air.

In a preferred binder composition of the invention (as defined above, preferably as defined above as being preferred)

the phenol-aldehyde resin an average molecular weight (Mw) in the range from 750 to 1000 g/mol, preferably in the range from 780 to 980 g/mol, and more preferably in the range from 850 to 980 g/mol, determined by means of gel permeation chromatography.

Surprisingly it has been found that binder compositions of the invention which comprise a phenol-aldehyde resin having an aforesaid preferred average molecular weight (Mw) lead to especially high flexural strength on the part of the resultant foundry moldings after a storage time of 24 hours and after 5 days under normal storage conditions and also after the wash treatment of the foundry moldings. It has surprisingly been found, moreover, that binder compositions of the invention which comprise a phenol-aldehyde resin having an average molecular weight (Mw) within the aforesaid particularly preferred range lead to especially high flexural strength on the part of the resultant foundry moldings after a storage time of 15 seconds (i.e., “initial strength”) under normal storage conditions. This makes it possible to produce especially delicate foundry moldings. In our own investigations, moreover, the resulting foundry moldings proved to be especially stable to atmospheric moisture; accordingly, they can be stored for a long time even without absence of air.

Preference is also given to a binder composition of the invention (as defined above, preferably defined above as being preferred), additionally comprising
one or more silanes in a total amount in the range from 0.5 to 11 wt %, preferably in the range from 2.5 to 10 wt %, more preferably in the range from 3.0 to 10 wt %, very preferably in the range from 3.5 to 7 wt %, especially very preferably in the range from 3.5 to 6 wt %, based on the total mass of the binder composition.

Surprisingly it has been found in the context of the present invention that binder compositions of the invention which comprise silanes in an (unusually high) overall amount in the range from 0.5 to 11 wt % or in the range from 2.5 to 10 wt %, based on the total mass of the binder composition, lead to particularly or especially solid and therefore also to particularly stable or especially stable foundry moldings. In our own investigations, the resultant foundry moldings proved to be particularly stable under atmospheric humidity; consequently, they can be stored for a long time even without absence of air.

It has surprisingly been found, moreover, that binder compositions of the invention which comprise the aforesaid preferred total amounts of one or more silanes lead to especially high strength on the part of the resultant foundry moldings after a storage time of 24 hours under normal storage conditions. Presumably, in the presence of
one or more silanes in a total amount in the range from 0.5 to 11 wt % or in the range from 2.5 to 10 wt %, based on the total mass of the binder composition,
   and
a phenol-aldehyde resin having an average molecular weight (Mw) in the range from 750 to 1200 g/mol, preferably in the range from 750 to 900 g/mol, and more preferably in the range from 750 to 800 g/mol, determined by means of gel permeation chromatography,
   there is in an interaction, presently not precisely specifiable, between the silanes and the phenol-aldehyde resin, which are responsible for the surprising effect in relation to the strengths.

Compounds of the formula VIII are preferred silanes for use in an aqueous alkaline binder composition of the invention.

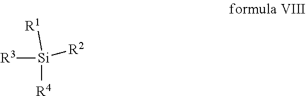

In formula VIII, R¹, R², R³, and R⁴ independently of one another (i.e., a substituent R¹ is defined, for example, independently of the substituent R², the substituent R³, and the substituent R⁴) are hydrogen, unsaturated or saturated aliphatic or aromatic groups with or without substituents; preferred substituents are oxygen, chlorine, nitrogen, sulfur, fluorine, bromine or iodine atoms.

Epoxysilanes are particularly preferred silanes for use in an aqueous alkaline binder composition of the invention; epoxysilanes are compounds of the formula VIII above in which one or more of the substituents R¹, R², R³, and R⁴ have at least one epoxy unit. An epoxy unit here is a three-membered ring in which, in comparison to cyclopropane, a carbon atom is replaced by an oxygen atom.

With particular preference R¹, R², R³, and R⁴ in formula VIII are selected independently of one another from the group consisting of
hydrogen,
alkoxy,
substituted and unsubstituted alkyl,
N-(aminoalkyl)aminoalkyl,
N,N-bis(aminoalkyl)aminoalkyl,
alkoxyalkyl,
epoxyalkoxyalkyl,
aryl,
alkoxyaryl,
aryloxy,
aralkyl
   and
alkaryl.

With very particular preference, R¹, R², R³, and R⁴ independently of one another are selected from the group consisting of
alkoxyl,
N-(aminoalkyl)aminoalkyl,
N,N-bis(aminoalkyl)aminoalkyl,
substituted and unsubstituted alkyl,
aryl,
alkoxyalkyl
   and
glycidyloxyalkyl (i.e., 3-(2,3-epoxypropoxy)alkyl).

Each of the above-defined substituents R¹, R², R³, and R⁴ preferably has a total number of carbon atoms in the range from 1 to 20, more preferably in the range from 1 to 10, very preferably in the range from 1 to 6.

With very particular preference, R¹, R², R³, and R⁴ independently of one another are preferably selected from the group consisting of
methoxy,
ethoxy,
1-methoxyethoxy,
n-propoxy,
3-aminopropyl,
N-(2-aminoethyl)-3-aminopropyl
   and
3-glycidyloxypropyl (i.e. 3-(2,3-epoxypropoxy)propyl).

Particularly preferred is a binder composition of the invention (as defined above, preferably as defined above as being preferred),

where one or more or all of the silanes used are selected from the group consisting of 3-aminopropyltriethoxysilane, N-(2-aminoethyl)-3-aminopropyltrimethoxysilane and phenyltrimethoxysilane and/or are selected from the group of epoxysilanes,

and where one or more of the silanes used are preferably selected from the group consisting of 3-(glycidyloxy)propyltriethoxysilane and 3-(glycidyloxy)propyltrimethoxysilane.

A binder composition of the invention preferably comprises exclusively silanes selected from the group consisting of 3-aminopropyltriethoxysilane, N-(2-aminoethyl)-3-aminopropyltrimethoxysilane, and phenyltrimethoxysilane, and/or selected from the group of epoxysilanes (preferably 3-(glycidyloxy)propyltriethoxysilane and 3-(glycidyloxy)propyltrimethoxysilane).

Especially preferred is a binder composition of the invention (as defined above as being particularly preferable) comprising as silanes
epoxysilanes, preferably selected from the group consisting of 3-(glycidyloxy)propyltriethoxysilane and 3-(glycidyloxy)propyltrimethoxysilane, in a total amount in the range from 0.5 to 11 wt %, preferably in the range from 2.5 to 7 wt %, more preferably 4 to 6 wt %, based on the total mass of the binder composition.

As well as epoxy silanes there may be further, different silanes present or (which is not preferable) there may be no such other silanes present.

Epoxysilanes at the concentrations indicated above lead to greater strength on the part of the resulting foundry moldings by comparison with other silanes, at the same concentration. In our own investigations, the resulting foundry moldings have proven to be especially stable to atmospheric humidity; consequently, they can be stored for a particularly long time even without exclusion of air.

Also preferred is a binder composition of the invention (as defined above, preferably as defined above as being preferred) where the negatively charged or uncharged phenol-aldehyde resin is a negatively charged or uncharged resole phenol-aldehyde resin, for curing with carbon dioxide gas in the phenol-resole-CO₂ process. The phenol-aldehyde resin in this case is preferably present in the form of an (uncharged) resole phenol-aldehyde resin in an alkaline medium and/or as an alkali metal salt of the resole phenol-aldehyde resin. The amount of alkali present in the binder composition is preferably sufficient to prevent, partially or completely, the formation of a stable complex between the oxyanion and the resin that is present in the binder composition.

Also preferred is a binder composition of the invention (as defined above, preferably as defined above as being preferred) further comprising
one or more compounds selected from the group consisting of polyalkylene glycols, phenylalkylene glycol ethers, propylene glycol alkyl ethers, substituted or unsubstituted pyrrolidones, monoethylene glycol and polyethylene glycol in a total amount in the range from 1 to 40 wt %, preferably in a total amount of 1 to 15 wt %, more preferably in the range from 2 to 4 wt %, based on the total mass of the binder composition
   and/or
reaction products of this or these compounds.

After addition to the further constituents of a binder composition of the invention, the aforesaid compounds react in the individual case with further components of a binder composition of the invention. They may react, for example, with cations (potassium cations, for example) which are present in the binder composition, similarly, for example, to the crown ether complexes, and/or they might react with the phenol-aldehyde resin or with the oxyanions to form ethers. The aforementioned compounds are not exclusively to be regarded as inert solvents, but instead appear to provide additional acceleration to the curing process. In one binder composition of the invention, therefore, the compounds themselves (as yet unreacted) and/or their reaction products are present—this is dependent on the particular preparation protocol.

The phenol-aldehyde resin of a binder composition of the invention is therefore preferably
(a) a phenol-aldehyde resin which has been modified by reaction with the aforementioned compounds,
(b) a phenol-aldehyde resin which has not been modified by reaction with the aforementioned compounds,
or
(c) a mixture of (a) and (b).

Further advantageous effects which come about through the presence or reaction of the aforementioned compounds in binder compositions of the invention are as follows:
(i) improved initial strengths of the resultant foundry moldings,
(ii) improved strengths of the cured foundry moldings after a defined storage time, such as 24 hours or longer, for example,
(iii) improved strengths of the resultant wash-treated foundry moldings,
(iv) improved flowability of the binder composition,
(v) resulting foundry moldings having an improved surface quality and/or an improved edge hardness,
   and/or
(vi) reduced odor emission, especially during the production of the foundry molding or during storage of the foundry moldings.

It is preferred for the aforementioned compounds selected from the group consisting of polyalkylene glycols, phenylalkene glycol ethers, propylene glycol alkyl ethers, substituted or unsubstituted pyrrolidones, monoethylene glycol, and polyethylene glycol to be present in a total amount in a range of from 1 to 15 wt %, preferably in the range from 2 to 4 wt %, based on the total mass of the binder composition of the invention, since the resultant foundry moldings possess improved storage properties and higher flexural strengths.

It is particularly preferred if in a binder composition of the invention as defined above, the compound, or at least one of the two or more compounds, as defined above is selected from the group of polyethylene glycols, these being present in a total amount of 3 to 15 wt %, based on the total mass of the binder composition.

Particularly preferred is a binder composition of the invention (as defined above, preferably as defined above as being preferred) further comprising
one or more compounds from the group consisting of C4-C20 saturated or unsaturated aliphatic carboxylic acids and alkali metal salts of said acids, in a total amount in the range from 0.1 to 5.0 wt %, preferably in a total amount of 0.5 to 3 wt %, preferably in a total amount of 0.8 to 1.5 wt %, based on the total mass of the binder composition.

Preferred or particularly preferred binder compositions as defined above have an improved flowability in comparison to binder compositions of the invention which do not include the compounds defined above.

Very particular preference is given to those binder compositions of the invention, defined above as being particularly preferred, comprising
one or both compounds from the group consisting of isononanoic acid and alkali metal salts of isononanoic acid, in a total amount in the range from 0.1 to 5.0 wt %, preferably in a total amount of 0.5 to 3 wt %, preferably in a total amount of 0.8 to 1.5 wt %, based on the total mass of the binder composition.

Especially preferred binder compositions of the invention which comprise isononanoic acid and/or alkali metal salts of isononanoic acid in the concentrations defined above are advantageous because such binder compositions exhibit an especially improved flowability.

Also preferred is a binder composition of the invention (as defined above, preferably defined above as being preferred) comprising
phenoxyethanol (phenyl monoethylene glycol ether) and/or butyldiglycol (diethylene glycol butyl ether) and/or monoethylene glycol in a total amount in the range from 3 to 10 wt %, preferably in the range of 3-6 wt %, based on the total mass of the binder composition.

Preferred binder compositions of the invention as defined above have the same advantageous technical effects already defined above for preferred binder compositions of the invention which comprise one or more compounds selected from the group consisting of polyalkylene glycols, phenylalkylene glycol ethers, propylene glycol alkyl ethers, substituted or unsubstituted pyrrolidones, monoethylene glycol, and polyethylene glycol.

Preference is also given to a binder composition of the invention (as defined above, preferably as defined above as being preferred), further comprising
1,3,5-trioxacyclohexane in a total amount in the range from 0.1 to 5%, preferably in the range from 0.5 to 1.5%.

The presence of 1,3,5-trioxacyclohexane leads to particular strength of the resultant foundry molding on casting. This advantageous technical effect is presumably attributable to the fact that, during decomposition of the 1,3,5-trioxacyclohexane on casting of the foundry molding, additional formaldehyde is liberated, and contributes to additional crosslinking between the oligomers of the phenol-aldehyde resin and hence to the particular strength of the resultant foundry molding.

Preference is also given to a binder composition of the invention (as defined above, preferably as defined above as being preferred) where the pH at 20° C. is in the range from 12 to 14, preferably in a range from 13 to 14.

Binder compositions having a pH of 12 to 14, more particularly having a pH of 13 to 14, may be stored for a prolonged period without any noticeable deterioration in the properties of the binder composition.

Preference is also given to a binder composition of the invention (as defined above, preferably as defined above as being preferred) where the molar amount of the phenol groups in the aqueous alkaline binder composition is in the range from 1.5 to 2.5 mol/kg, preferably in the range from 1.8 to 2.0 mol/kg, based on the total mass of the binder composition and/or the viscosity of the alkaline binder composition at 20° C. is in the range of 100-1000 mPas, preferably 150-700 mPas, more preferably 150-500 mPas, determined in accordance with DIN EN ISO 3219:1994. For further details of the measurement method, see below.

With the preferred binder compositions of the invention as defined above it is possible to produce particularly stable (strong) foundry moldings. The above-defined amount of phenol groups is preferably a constituent of a phenol-aldehyde resin having an average molecular weight (Mw) in the range from 750 to 1200 g/mol. With regard to preferred average molecular weights, the statements above are valid correspondingly.

On establishment of a preferred viscosity, the mixing of the aqueous alkaline binder composition of the invention with foundry molding material, and also the processing of the resultant molding mixture in a core shooting machine, present particularly little problem.

Preference is also given to a binder composition of the invention (as defined above, preferably as defined above as being preferred) where the molar ratio of the total amount of alkali metals to phenol groups is in the range from 1.0:1 to 2.5:1, preferably in the range from 1.5:1 to 2.1:1, more preferably in the range from 1.7:1 to 1.9:1 and/or where the molar amount of the alkali metals in the aqueous alkaline binder composition is in the range from 1.0 to 7.5 mol/kg, preferably in the range from 2.0 to 6.0 mol/kg, more preferably in the range from 3.0 to 4.0 mol/kg, based on the total mass of the binder composition.

Preference is also given to a binder composition of the invention (as defined above, preferably as defined above as being preferred) where the molar ratio of the total amount of potassium cations to the total amount of sodium cations is in the range from 47:1 to 59:1, preferably in the range from 50:1 to 56:1, more preferably in the range from 52:1 to 55:1.

Above-described binder compositions of the invention have the further advantage that, as a result of the defined amount and/or as a result of the defined ratio, they achieve optimum reactivity for curing with carbon dioxide gas in conjunction with sufficient storage stability on the part of the above-described binder compositions.

Preference is given in particular to a binder composition of the invention (as defined above, preferably as defined above as being preferred) for curing with carbon dioxide gas in the phenol-resole-CO₂ process, comprising
a negatively charged or uncharged phenol-aldehyde resin, comprising phenol groups, which is selected from the group consisting of resoles and mixtures comprising one or more resoles and also one or more novolacs,
   where the phenol-aldehyde resin possesses an average molecular weight (Mw) in the range from 750 to 1200 g/mol, preferably in the range from 800 to 1100 g/mol and more preferably in the range from 850 to 1000 g/mol, determined by means of gel permeation chromatography,
an oxyanion selected from the group consisting of borate ions, aluminate ions, stannate ions, zirconate ions, titanate ions and mixtures therefore, for forming a stable complex with the negatively charged or uncharged phenol-aldehyde resin,
   and also
one or more epoxysilanes, preferably selected from the group consisting of 3-glycidyloxypropyltriethoxysilane and 3-glycidyloxypropyltrimethoxysilane, in a total amount in the range from 0.5 to 11 wt %, preferably in the range from 2.5 to 10 wt %, based on the total mass of the binder composition,
   where the total molar amount of the phenol groups of the phenol-aldehyde resin in the aqueous alkaline binder composition is in the range from 1.8 to 2.0 mol/kg, based on the total mass of the aqueous alkaline binder composition.

The above-defined specific binder composition of the invention leads to especially strong foundry moldings.

The present invention also relates to a use of an aqueous alkaline binder composition as defined above (preferably as defined above as being preferred) as a binder for a foundry molding material, preferably in a method in which the binder is cured by gassing with carbon dioxide gas.

All aspects of the invention which have been disclosed above in connection with the binder composition of the invention are also valid mutatis mutandis for the use according to the invention (as just defined) and for a corresponding molding mixture of the invention, and also for a corresponding method for producing a foundry molding and a corresponding foundry molding (each as defined below). Similarly, all aspects which are stated in connection with a use, with a molding mixture for producing foundry molding, and with a corresponding method for producing a foundry molding, and with a corresponding foundry molding, are also valid mutatis mutandis for an aqueous alkaline binder composition in accordance with the present invention.

The present invention also relates to a molding mixture for producing a foundry molding, comprising
an aqueous alkaline binder composition of the invention as defined above (preferably as defined above as being preferred)
   and
a foundry molding material.

The term “foundry moldings” encompasses, in particular, cores, molds, and feeder elements for use in casting.

The aqueous alkaline binder composition is suitable for curing with carbon dioxide gas in the presence of the foundry molding material. The molding mixture overall is therefore curable with carbon dioxide gas.

The term “foundry molding material” encompasses, in particular, molding sands, chamottes, hollow beads, and core-shell particles. Foundry molding materials are preferably refractory.

The refractory foundry molding material (which is in addition preferably free-flowing) used is frequently silica sand, but also other foundry molding materials such as, for example, zircon sands, chromite sands, chamottes, olivine sands, hollow beads, core-shell particles, feldspar-containing sands, and andalusite sands.

The bulk density of the molding mixture (for producing feeder elements) is preferably 2 g/cm³ or less, more preferably 1.6 g/cm³ or less, very preferably 1.2 g/cm³ or less, especially preferably 1 g/cm³ or less, even more preferably 0.8 g/cm³ or less, ideally 0.7 g/cm³ or less.

The mass ratio of the total amount of aqueous alkaline binder composition of the invention to the total amount of foundry molding material in a binder composition of the invention is preferably in the range from 10:100 to 0.5:100, more preferably in the range from 5:100 to 1:100.

The present invention also relates to a method for producing a foundry molding (e.g., mold, core, or feeder element), having the following steps:
producing or providing a molding mixture as defined above,
molding the molding mixture produced or provided,
curing the molded molding mixture by gassing with carbon dioxide gas.

A wash composition is preferably applied to the surface of a foundry molding (preferably a core) present after curing the shaped molding mixture by gassing with carbon dioxide gas, for the purpose of smoothing the surface structure, thus resulting in a wash-treated (and therefore smoothed) foundry molding (preferably core).

All aspects of the invention which have been stated above in connection with an aqueous alkaline binder composition for curing with carbon dioxide are also valid mutatis mutandis for a corresponding method for producing a foundry molding and for a corresponding foundry molding. Similarly, all aspects stated below in connection with a corresponding method for producing a foundry molding and with a corresponding foundry molding are also valid mutatis mutandis for an aqueous alkaline binder composition in accordance with the present invention.

The present invention also relates to a corresponding foundry molding (e.g., mold, core or feeder element),

producible by a method of the invention for producing a foundry molding, as defined above.

A foundry molding of the invention, more particularly a core of the invention, is preferably wash-treated. This means that on the surface of the core there is located, or the surface of the core is formed by, wash material. Wash material is generally a mixture of substances, which in particular includes refractory material.

The following measurement methods are used in the examples that are elucidated later on below.

Measurement Method (Flexural Strength):

The measurement method used for the flexural strength is subject to the following details:

The performance testing of the flexural strength of flexural bars produced with inventive and noninventive binder compositions takes place in a method based on VDG data sheet P73, method F (in [N/cm²]). 4 kg of H32 silica sand (Quarzwerke GmbH, Frechen) are charged to a suitable mixing vessel. 120 g of a (inventive or noninventive) binder composition (3 wt %, based on the 4 kg of H32 silica sand) are added, to give a premix. The premix is placed in an RN10/20 mixer from Multiserw, and the mixing time is 2 minutes on level 4. This results in a sand mixture.

Flexural bars are produced using an LUT-c core shooting machine from Multiserw. For this purpose, the freshly produced sand mixture is introduced into the shooting head of the machine. The flexural bars are shot with a shooting pressure of 5 bar in a shot time of 3 seconds. The shot flexural bar precursors are gassed with 1 bar CO₂ for 15 seconds. After CO₂ gassing has taken place, the core (i.e., the resulting flexural bar) is flushed with air for 10 seconds and then removed from the core box.

The resulting flexural bar is subsequently stored for a certain time (see option a) below) or wash-treated (see option b) below).
a) Flexural strength of the flexural bars after 15 s, 1 hour, 24 hours, and 5 days:
   The strength testing is carried out after different storage times of the flexural bars. The storage time of the flexural bars after removal from the machine is
      15 seconds (identified hereinafter as “flexural strength after 15 seconds”),
      1 hour (identified hereinafter as “flexural strength after 1 hour”),
      24 hours (identified hereinafter as “flexural strength after 24 hours”),
   and
      5 days after removal (identified hereinafter as “flexural strength after 5 days”).
   Prior to testing, the flexural bars are stored in a fume cupboard at 20° C. (+/−2° C.) and a relative humidity of 47% (+/−2%).
   The subsequent strength testing of the flexural bars takes place with a Multiserw LR-u-2e test instrument from Multiserw. For this purpose, the respective stored flexural bar is inserted into the machine and broken.
b) Wash test (production of wash-treated flexural bars):
   In a further test, referred to as the wash test, the resulting flexural bars are stored in a fume cupboard for an hour and then covered with a water wash (Arkopal 6804, from Hüttenes-Albertus). The damp flexural rods are dried in an oven at 150° C. for 30 minutes, cooled in a fume cupboard, and then the flexural strength of the wash-treated flexural bars is determined in accordance with VDG data sheet P 73 in [N/cm²].
   The subsequent strength testing of the flexural bars takes place with a Multiserw LR-u-2e test instrument from Multiserw. For this purpose, the respective wash-treated flexural bar is inserted into the machine and broken. The results of the flexural strength measurements on the resulting wash-treated flexural bars are identified below as flexural bars “after wash treatment”.

Measurement Method (Weight Average of the Molar Masses, i.e., Average Molecular Weight Mw):

Gel permeation chromatography was carried out to determine the average molecular weight Mw on an HPLC 1260 instrument from AGILENT.

Analytical Conditions:
Eluent: 1 M KOH (aqueous, 1-molar potassium hydroxide solution)
Precolumn: PSS MCX, 5 jm, guard, ID 8.0 mm×300 mm
Column: PSS MCX, 5 jm, 500 Â, ID 8.0 mm×300 mm
Pump: PSS SECcurity 1260 HPLC pump
Flow rate 0.5 mL/min
Injection system:
PSS SECcurity 1260 autosampler
Injection volume: 10 μL
Sample concentration: 2 g/L
Temperature: 23° C.
Detectors: PSS SECcurity 1260 differential refractometer (RID) and PSS SECcurity 1290 UV detector (A=254 nm)
Analysis: PSS-WinGPC UniChrom Version 8.2

Sample Preparation:
The samples were weighed out on an analytical balance and admixed with a calculated volume of the eluent. The sample concentration set was 2 g/L. The samples were then dissolved at room temperature in the initially introduced, calculated volume of the eluent, and injected for measurement without filtration beforehand.

Calibration and Analysis:
First of all, a calibration with pullulan standards was carried out. The molar mass average values and their distribution were calculated with computer assistance by means of the strip method, based on the pullulan calibration plot.
The weight average of the molar masses, i.e., average molecular weight Mw, was determined on the basis of the following formula:

$${M}_{w} = \frac{Σ {w}_{i} \cdot {M}_{i}}{Σ {w}_{i}}$$

where nᵢ=number of molecules in a fraction
   wᵢ=mass of the molecules in a fraction
   and
   Mᵢ=molar mass of a fraction.

Measurement Method (Viscosity of the Aqueous Alkaline Binder Composition):

The viscosity of the aqueous alkaline binder composition was determined at a temperature of 20° C. by means of the HAAKE Viscotester 550 instrument from Thermo Fisher Scientific in combination with the SV1 spindle/measuring device, in accordance with DIN EN ISO 3219:1994.

### EXAMPLES

The examples below are intended to illustrate the invention without limiting it.

The abbreviation “pbw” used in the examples denotes parts by weight (parts by mass).

### Example 1

General Preparation Protocol—Production of a Binder Composition with Variable Fraction of Silane and Variable Molecular Weight of a Resole Prepared:

A binder composition is produced as follows:

Production Step 1:

A premix is prepared by mixing
174.8 pbw of phenol and
1.72 pbw of boric acid.

Production Step 2:

Added to the premix from production step 1 are
8.4 pbw of trioxane (i.e., 1,3,5-trioxacyclohexane) and
7.7 pbw of an aqueous solution with 33 wt % of NaOH (i.e., sodium hydroxide solution 33%, aqueous).

Production Step 3:

The mixture is heated to 65° C. and
243.2 pbw of a 53% strength formaldehyde solution
   are metered in over a period of 45 minutes.

Production Step 4:

The reaction mixture is heated to 80° C. and condensed at a temperature between 80 and 90° C. until the resulting mixture has a viscosity of 300 mPas at 25° C.

Production Step 5:

After having attained the desired viscosity, the reaction mixture is admixed with 76.1 pbw of an aqueous solution with 45 wt % KOH (i.e., potassium hydroxide solution, 45% strength, aqueous)

Production Step 6:

Subsequently, at a temperature of 70° C., condensation is carried out until the resole of the reaction mixture has a defined average molecular weight Mw.

Note: The average molecular weight Mw for specific examples is indicated in Table 2 below.

Production Step 7:

As soon as the defined average molecular weight has been attained, the reaction mixture is cooled to 40° C. in less than 5 minutes.

Production Step 8:

This is followed by addition of 299.1 pbw of an aqueous solution with 45 wt % of KOH, 9.5 pbw of 3,5,5-trimethylhexanoic acid, 48.1 pbw of borax (CAS number 1303-96-4), 0.072 pbw of aluminum hydroxide and 88 pbw of polyethylene glycol having an average molecular weight of 200 g/mol (CAS No.: 25322-68-3) to the reaction mixture, which is subsequently cooled to below 30° C.

Production Step 9:

After cooling to a temperature of below 30° C. has taken place, a defined amount of 3-glycidyloxypropyltrimethoxysilane is added.

Note: The amount of silane used in specific examples is indicated in Table 1 below.

### Example 2

Production of Binder Compositions with Different Amounts of Silane:

In accordance with the preparation protocol above (Example 1), binder compositions of the invention were produced with different amounts of silane (cf. Example 1, production step 7) and were each processed to form flexural bars as described above. After a storage time differing in duration (see option a) under measurement method (flexural strength)) and/or after wash treatment (see option b) under measurement method (flexural strength)), the strengths of the respective flexural bars were ascertained.

Condensation was carried out in each case up to an average molecular weight Mw for the resole of approximately 784 g/mol (cf. Example 1, production step 4).

The amounts of silane used (in wt %, based on the total mass of the binder composition) and the results of the flexural strength measurements are set out in Table 1:

TABLE 1

| Amount of silane | | | |
|---|---|---|---|
| (3-glycidyloxy- | | | |
| propyltrimethoxy- | Flexural strengths [N/cm²] | | |
| silane) | after 24 | after 5 | after wash |
| [wt %] | hours | days | treatment |
| 0.5 | 160 | 90 | 230 |
| 1 | 180 | 100 | 250 |
| 2 | 190 | 110 | 250 |
| 3 | 200 | 140 | 280 |
| 4 | 210 | 170 | 300 |
| 5 | 220 | 170 | 290 |
| 6 | 200 | 170 | 300 |
| 7 | 190 | 160 | 290 |
| 8 | 180 | 150 | 290 |
| 9 | 170 | 130 | 290 |
| 10 | 140 | 110 | 290 |

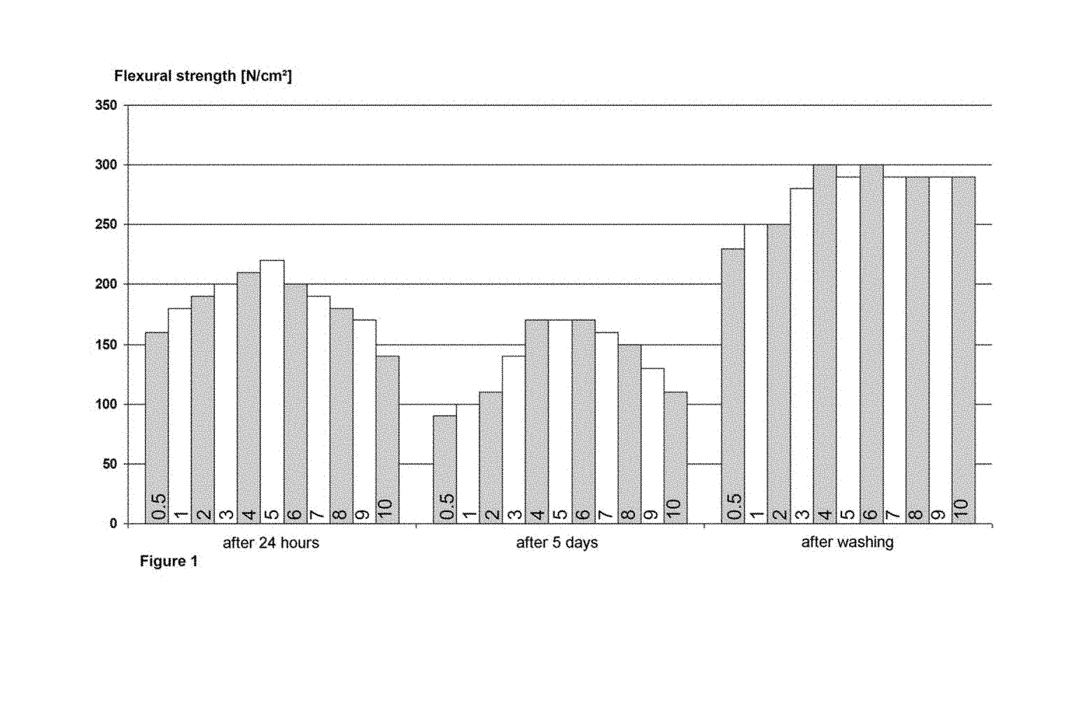

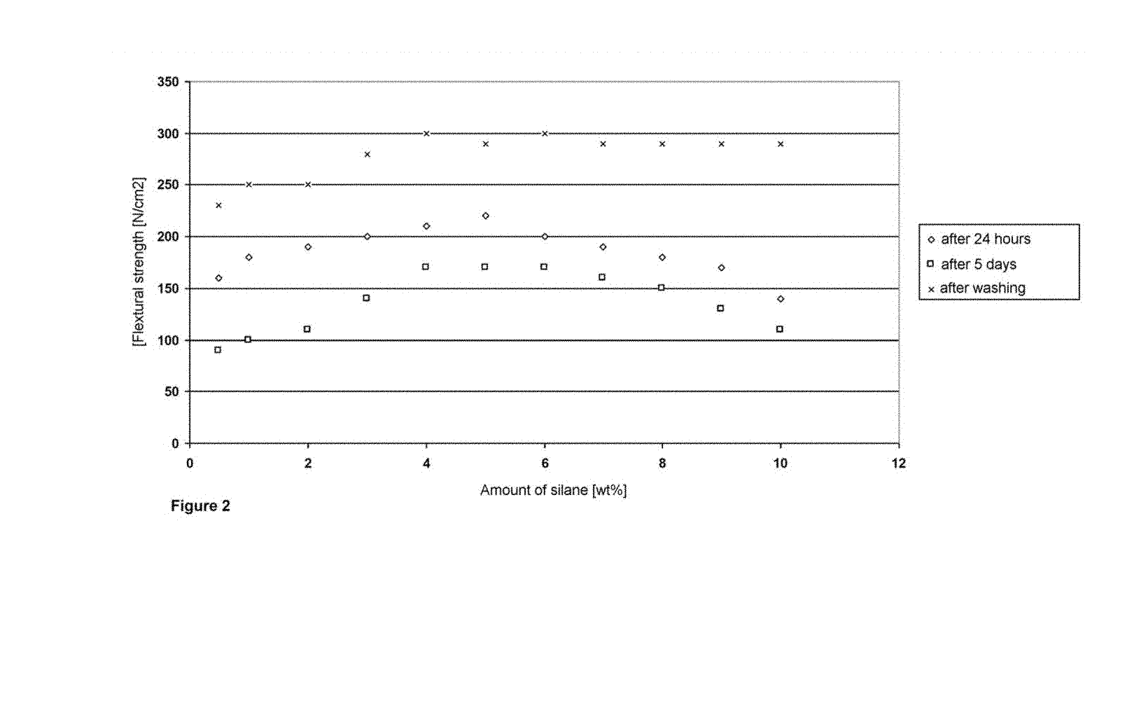

The results of Table 1 are shown in graph form in FIGS. 1 and 2. For reasons of clarity, FIG. 2 contains a selection of the data from Table 1.

FIG. 1 shows flexural strengths of flexural bars produced in accordance with Example 2 with different amounts of silane, after 24 hours and after 5 days' storage, and also after wash treatment. For each of the aforementioned storage times, and for the case where the flexural bars were wash-treated, respectively, 10 binder compositions in each case were used with different amounts of silane (0.5 to 10 wt %) (see x-axis in FIG. 1) in order to investigate the relationship between the flexural strength and the amount of silane used. The numbers in the bars of FIG. 1 relate to the amount of silane in wt % that was used for producing the respective flexural bar (i.e., the number “0.5” in the first bar of the measurement series “after 24 hours” in FIG. 1 denotes that an amount of silane of 0.5 wt % was used in order to produce the flexural bar employed).

FIG. 2 shows a selection of the flexural strengths of the flexural bars produced in accordance with Example 2 with different amounts of silane (after a storage time of 24 hours or 5 days, and, respectively after wash treatment). In FIG. 2, in contrast to FIG. 1, the amount of silane in wt % is indicated exclusively on the X-axis.

In FIG. 2 it is readily apparent that all of the compositions of the invention comprising more than 2 wt % of 3-glycidyloxypropyltrimethoxysilane exhibit higher flexural strengths in the measurements “after wash treatment” and “after 5 days” than those compositions of the invention for which the silane content is lower.

It is evident from FIG. 2, moreover, that in the “after 24 hours” column, for concentrations of 3-glycidyloxypropyltrimethoxysilane in the range of 4-6 wt %, the value measured for the flexural strength is particularly high. In contrast to this, the values for the measurements “after 24 hours” are lower both at lower silane concentrations (<4 wt %) and at higher silane concentrations (>6 wt %).

Measurements with a composition of the invention comprising an amount of 3-glycidyloxypropyltrimethoxysilane in the range from 4 to 6 wt % are therefore linked to a number of surprising technical effects (cf. also FIGS. 1 and 2), namely
a) a particularly high measurement in the “after wash treatment” column (and analogously “after 5 days”)
   and
b) (additionally) a high measurement value in the column “after 24 hours”.

### Example 3

Production of Binder Compositions with Resoles Having Different Average Molecular Weights Mw:

Binder compositions were produced with resoles having different average molecular weights Mw, and, after a variable storage time (see option a) under “measurement method (flexural strength)”) and/or after wash treatment (see option b) under “measurement method (flexural strength)”), the respective flexural bars were investigated for their strength.

In this case, 5 wt % of 3-glycidyloxypropyltrimethoxysilane was used each time, based on the total mass of the binder composition.

The results are set out in Table 2:

TABLE 2

| Average molecular | | | | | |
|---|---|---|---|---|---|
| weight Mw | Flexural strengths [N/cm²] | | | | |
| of the resole | after 15 | after 1 | after 24 | after 5 | after wash |
| (g/mol) | seconds | hour | hours | days | treatment |
| 724 | 80 | 180 | 110 | 110 | 110 |
| 731 | 100 | 200 | 160 | 120 | 160 |
| 784 | 110 | 210 | 210 | 160 | 350 |
| 814 | 110 | 210 | 200 | 160 | 330 |
| 876 | 130 | 200 | 200 | 140 | 320 |
| 960 | 130 | 200 | 200 | 140 | 320 |

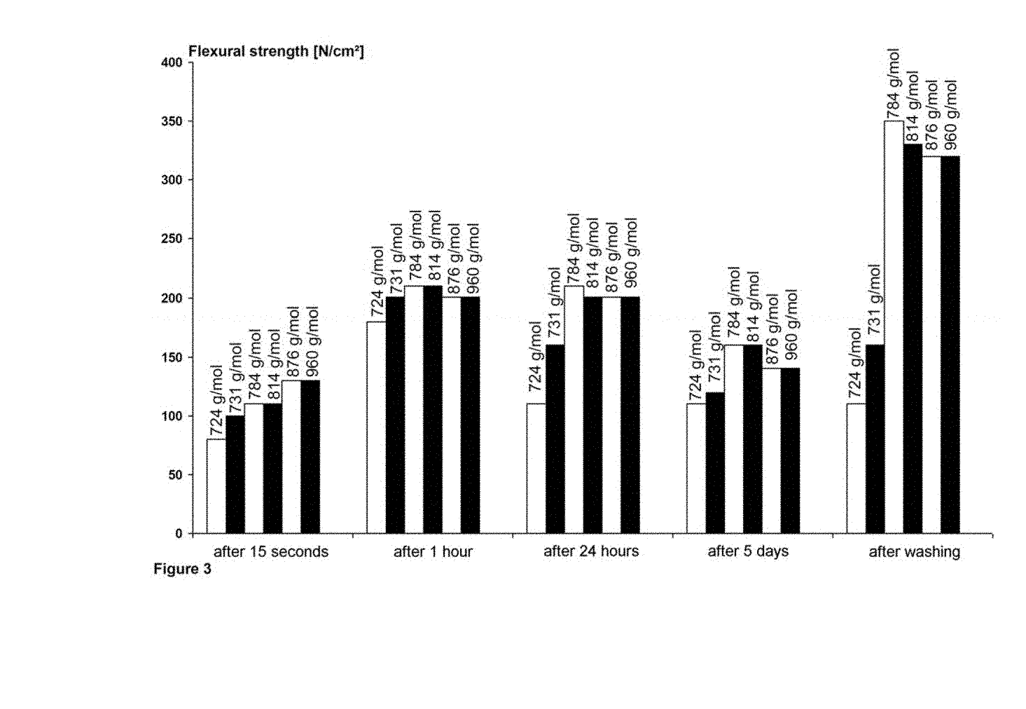

The results of Table 2 are shown in graph form in FIG. 3.

All of the compositions of the invention comprising resoles having a molecular weight Mw of more than 750 g/mol showed a higher or unchanged flexural strengths in comparison with the noninventive mixtures comprising phenol-aldehyde resins and/or salts thereof with a molecular weight Mw of less than 750 g/mol, in all of the measurements (flexural bars after storage for 15 seconds, for 1 hour, for 24 hours, for 5 days, and after wash treatment). This is true especially of the initial strengths (i.e., flexural strength after 15 seconds) and of the flexural strengths of the wash-treated foundry moldings. For (preferred) molecular weights in the range from 850 to 980 g/mol (namely 876 and 960 g/mol, respectively), particularly high flexural strengths were determined for the initial strengths (i.e., flexural strength after 15 seconds).

1-20. (canceled)

21. An aqueous alkaline binder composition for curing with carbon dioxide gas, comprising
a negatively charged or uncharged phenol-aldehyde resin, comprising phenol groups, which is selected from the group consisting of resoles and mixtures comprising one or more resoles and also one or more novolacs,
an oxyanion, selected from the group consisting of borate ions, aluminate ions, stannate ions, zirconate ions, titanate ions, and mixtures thereof, for forming a stable complex with the resole phenol-aldehyde resin,
one or more silanes in a total amount in the range from 3.0 to 10 wt % based on the total mass of the binder composition, where one or more or all of the silanes used are selected from the group consisting of epoxysilanes,
where the total molar amount of the phenol groups of the phenol-aldehyde resin in the aqueous alkaline binder composition is in the range from 1 to 3 mol/kg, based on the total mass of the aqueous alkaline binder composition, and
where the phenol-aldehyde resin possesses a weight average of the molar masses (Mw) in the range from 750 to 1200 g/mol, determined by means of gel permeation chromatography.

22. The aqueous alkaline binder composition as claimed in claim 21, where
the phenol-aldehyde resin a weight average of the molar masses (Mw) in the range from 750 to 1000 g/mol, preferably in the range from 780 to 980 g/mol and more preferably in the range from 850 to 980 g/mol, determined by means of gel permeation chromatography.

23. The aqueous alkaline binder composition as claimed in claim 21, comprising as silanes
epoxysilanes selected from the group consisting of 3-(glycidyloxy)propyltriethoxysilane and 3-(glycidyloxy)propyltrimethoxysilane, in a total amount in the range from 4 to 6 wt %, based on the total mass of the binder composition.

24. The aqueous alkaline binder composition as claimed in claim 21, where the negatively charged or uncharged phenol-aldehyde resin is a negatively charged or uncharged resole-phenol-aldehyde resin, for curing with carbon dioxide gas in the phenol-resole-CO₂ process.

25. The aqueous alkaline binder composition as claimed in claim 21, further comprising
one or more compounds selected from the group consisting of polyalkylene glycols, phenylalkylene glycol ethers, propylene glycol alkyl ethers, substituted or unsubstituted pyrrolidones, monoethylene glycol and polyethylene glycol in a total amount in the range from 1 to 40 wt %, preferably in a total amount of 1 to 15 wt %, based on the total mass of the binder composition and/or
reaction products of this or these compounds.

26. The aqueous alkaline binder composition as claimed in claim 21, further comprising
one or more compounds from the group consisting of C4-C20 saturated or unsaturated aliphatic carboxylic acids and alkali metal salts of said acids, preferably from the group consisting of isononanoic acid and alkali metal salts of isononanoic acid, in a total amount in the range from 0.1 to 5.0 wt %, preferably in a total amount of 0.5 to 3 wt %, preferably in a total amount of 0.8 to 1.5 wt %, based on the total mass of the binder composition.

27. The aqueous alkaline binder composition as claimed in claim 21, further comprising
phenoxyethanol and/or butyldiglycol and/or monoethylene glycol in a total amount in the range from 3 to 10 wt %, preferably in the range of 3-6 wt %, based on the total mass of the binder composition and/or
1,3,5-trioxacyclohexane in a total amount in the range from 0.1 to 5%, preferably in the range from 0.5 to 1.5%.

28. The aqueous alkaline binder composition as claimed in claim 21, where the pH at 20° C. is in the range from 12 to 14, preferably in a range from 13 to 14.

29. The aqueous alkaline binder composition as claimed in claim 21, where
the molar amount of the phenol groups in the aqueous alkaline binder composition is in the range from 1.5 to 2.5 mol/kg, preferably in the range from 1.8 to 2.0 mol/kg, based on the total mass of the binder composition and/or
the viscosity of the alkaline binder composition at 20° C. is in the range of 100-1000 mPas, preferably 150-700 mPas, more preferably 150-500 mPas, determined in accordance with DIN EN ISO 3219:1994.

30. The aqueous alkaline binder composition as claimed in claim 21, where the molar ratio of the total amount of alkali metals to phenol groups is in the range from 1.0:1 to 2.5:1, preferably in the range from 1.5:1 to 2.1:1, more preferably in the range from 1.7:1 to 1.9:1 and/or
where the molar amount of the alkali metals in the aqueous alkaline binder composition is in the range from 1.0 to 7.5 mol/kg, preferably in the range from 2.0 to 6.0 mol/kg, more preferably in the range from 3.0 to 4.0 mol/kg, based on the total mass of the binder composition.

31. The aqueous alkaline binder composition as claimed in claim 21, ratio of the total amount of potassium cations to the total amount of sodium cations is in the range from 47:1 to 59:1, preferably in the range from 50:1 to 56:1, more preferably in the range from 52:1 to 55:1.

32. A method of forming a foundry molding material, comprising:
producing or providing an aqueous alkaline binder composition as claimed in claim 21 as a binder for the foundry molding material.

33. The method as claimed in claim 32, further comprising cured the binder by gassing with carbon dioxide gas.

34. A molding mixture for producing a foundry molding, comprising
an aqueous alkaline binder composition as claimed in claim 21 and
a foundry molding material.

35. A method for producing a foundry molding, having the following steps:
producing or providing a molding mixture as claimed in claim 34,
molding the molding mixture produced or provided,
curing the molded molding mixture by gassing with carbon dioxide gas.

36. A foundry molding producible by a method as claimed in claim 35.
